(19) United States
(12) Patent Application Publication
(10) Pub. No.: US 2006/0177720 A1
(43) Pub. Date: Aug. 10, 2006

(54) Reinforced composite ionic conductive polymer membrane, fuel cell adopting the same, and method of making the same

(76) Inventor: Hae-kyoung Kim, Yongin-city (KR)

Correspondence Address: LEE & MORSE, P.C., 1101 WILSON BOULEVARD, SUITE 2000, ARLINGTON, VA, 22209, US

(21) Appl. No.: 11/348,268

(22) Filed: Feb. 7, 2006

Related U.S. Application Data
(63) Continuation-in-part of application No. 09/931,862, filed on Aug. 20, 2001, now abandoned.

(51) Int. Cl. H01M 8/10; C08J 5/22

(52) U.S. Cl. 429/33; 521/27

(57) ABSTRACT

A method of making a membrane including forming a porous support, the porous support including a polymer and a reinforcing agent, and applying an ion-exchange polymer to the porous support, a membrane including a porous support and an ion-exchange polymer, wherein the porous support includes a polymer and a reinforcing agent and the ion-exchange polymer is applied to the porous support, and the porous support is formed by forming a first mixture including a reinforcing agent and at least one of a polymer and a polymer precursor and processing the first mixture to form the porous support, and a fuel cell adopting the same.

This application is a continuation-in-part application of U.S. patent application Ser. No. 09/931,862, filed on Aug. 20, 2001, which is incorporated by reference herein in its entirety.

### BACKGROUND OF THE INVENTION

1. Field of the Invention

The present invention relates to a reinforced composite ionic conductive polymer membrane, a fuel cell adopting the same, and a method of making the same. More particularly, the present invention relates to a reinforced composite ionic conductive polymer membrane which is improved in ionic conductivity, moisture retention, and reduced cross-over of liquid fuel by addition of a reinforcing agent, to a fuel cell with improved efficiency that includes the reinforced composite ionic conductive polymer membrane, and to a method of making the same.

2. Description of the Related Art

Recent advances in portable electronic devices, wireless communications devices, and fuel cell-based vehicles have increased the need for development of a reliable, high-performance fuel cell workable at or near room temperature.

A fuel cell is a new power generating system that converts energy produced through electrochemical reactions of fuel and oxidative gas directly into electric energy. Exemplary fuel cells include a fuel cell with molten carbonate salt, which is operable at a high temperature of 500-700° C., a fuel cell with phosphoric acid operable around 200° C., an alkaline electrolyte fuel cell operable between room temperature and less than 100° C., a solid polymer electrolyte (SPE) fuel cell operable at a temperature of about room temperature or higher, e.g., 50-80° C., and a solid oxide fuel cell operable at a temperature of 600-1000° C.

SPE fuel cells include proton-exchange membrane fuel cells (PEMFCs) using hydrogen gas as a fuel source and direct methanol fuel cells (DMFCs) which generate power using a liquid methanol solution which is directly applied to the anode as a fuel source.

The PEMFC, which is emerging as a next-generation, clean energy alternative to fossil fuels, has a high power density and high energy conversion efficiency. In addition, the PEMFC is workable at room temperature and is easy to seal and miniaturize, so it can be extensively applied to the fields of zero-emission vehicles, power generating systems for home appliances, mobile telecommunications equipment, medical equipment, military equipment, equipment in space, and portable power generating systems.

The basic structure of the PEMFC as a power generator for producing direct current through an electrochemical reaction of hydrogen and oxygen is shown in FIG. 1. Referring to FIG. 1, the PEMFC has a proton-exchange membrane 11 interposed between the anode and the cathode. The proton-exchange membrane 11 is formed of a SPE with a thickness of about 20 to about 200 μm. The anode and cathode include anode and cathode backing layers 14 and 15, respectively, for supplying fuel gases, and catalyst layers 12 and 13, respectively, for oxidation/reduction of the fuel gases, forming gas diffusion electrodes (hereinafter, the anode and cathode will be referred to as “gas diffusion electrodes”). In FIG. 1, reference numeral 16 represents a current collector.

As hydrogen, used as a reaction gas, is supplied to the PEMFC having the structure described above, hydrogen molecules are dissociated into protons and electrons by an oxidation reaction in the anode. The protons move to the cathode through the proton-exchange membrane 11. In the cathode, oxygen molecules take electrons from the anode and are reduced to oxygen ions by reduction. The oxygen ions react with protons from the anode to produce water.

As shown in FIG. 1, in the gas diffusion electrodes of the PEMFC, the catalyst layers 12 and 13 are formed on the anode and cathode backing layers 14 and 15, respectively. The anode and cathode backing layers 14 and 15 may be formed of, e.g., carbon cloth or carbon paper. The surfaces of the anode and cathode backing layers 14 and 15 may be treated for easy reaction gas access and for water permeability to the proton-exchange membrane 11.

The DMFC has the same structure as the PEMFC described above, but uses liquid methanol, instead of hydrogen, as a fuel source. As methanol is supplied to the anode, an oxidation reaction occurs in the presence of a catalyst to generate protons, electrons, and carbon dioxide. Although the DMFC has lower energy efficiency than the PEMFC, use of a liquid fuel in the DMFC makes its application to, e.g., portable electronic devices, easier.

In the fuel cells described above, an ionic conductive polymer membrane is used as a proton-exchange membrane interposed between the anode and the cathode. The ionic conductive polymer membrane may be formed of, e.g., a polymer electrolyte having a sulfonic acid group, and may retain water. The sulfonic acid group is dissociated from the molecular structure in the water medium to form a sulfonyl group. Thus, the ionic conductive polymer membrane exhibits ionic conductivity.

The more sulfonic acid groups existing in the polymer electrolyte and the greater the amount of water incorporated into the polymer electrolyte, the greater the degree of dissolution of the sulfonyl group and the greater the ionic conductivity. For this reason, it is preferable to use a highly sulfonated polymer electrolyte as the proton-exchange membrane.

However, it is difficult to process highly sulfonated polymers into a film. Thus, it is necessary to adjust the degree of sulfonation of the polymer within a predetermined range to attain good ionic conductivity and ease of processibility into a film.

As the working temperature is raised, the ionic conductive polymer membrane can become dry, although catalytic activity becomes higher and ionic conduction is facilitated. The drying of the ionic conductive polymer membrane can be compensated for, to some extent, by using a humidified fuel source, but such a humidified fuel source may not be easily applied to a room temperature-workable cell. This is because the temperature of the cell is raised by the humidified fuel source, and thus the cell temperature may become elevated. In addition, a fuel humidifying system may be required for the cell to supply the humidified fuel source.

To account for this problem, preparation of an ionic conductive polymer membrane by impregnating ion-exchange polymers into a porous support has been suggested. Forming the ionic conductive polymer membrane itself is easy with this method, but moisture retention by the ionic conductive polymer membrane may be limited. Thus, an ionic conductive polymer membrane that has excellent moisture retention and that is capable of being easily formed into a film cannot be obtained by conventional methods at this time.

Also, the DMFC has the problem of performance reduction due to low fuel efficiency caused by cross-over of methanol through the ionic conductive polymer membrane.

### SUMMARY OF THE INVENTION

The present invention is therefore directed to a reinforced composite ionic conductive polymer membrane, a fuel cell adopting the same, and a method of making the same, which substantially overcome one or more of the problems due to the limitations and disadvantages of the related art.

It is therefore a feature of an embodiment of the present invention to provide a reinforced composite ionic conductive polymer membrane in which a reinforcing agent is added, providing excellent ionic conductivity and ease of film formation.

It is therefore another feature of an embodiment of the present invention to provide a fuel cell with improved efficiency having a reinforced composite ionic conductive polymer membrane.

It is therefore yet another feature of an embodiment of the present invention to provide a direct methanol fuel cell (DMFC) with improved efficiency and reducing cross-over of methanol.

At least one of the above and other features and advantages of the present invention may be realized by providing a method of making a membrane including forming a porous support, the porous support including a polymer and a reinforcing agent, and applying an ion-exchange polymer to the porous support.

Forming the porous support may include forming a first mixture including a reinforcing agent and at least one of a polymer and a polymer precursor, and processing the first mixture to form the porous support. The first mixture may further include an extractable material, and processing the first mixture to form the porous support may include forming the first mixture into a membrane, and substantially removing the extractable material from the membrane by extracting the extractable material using a solvent.

Approximately equal weights of the extractable material and the at least one of a polymer and a polymer precursor may be present in the first mixture. Forming the first mixture into a membrane may include casting the first mixture.

Applying the ion-exchange polymer to the porous support may include forming a second mixture including an ion exchange material and a solvent. Applying the ion-exchange polymer to the porous support may further include applying the second mixture to the porous support and then substantially removing the solvent.

The polymer may be selected from the group consisting essentially of polytetrafluoroethylene, polyvinylidenefluoride, vinylidene fluoride-hexafluoropropylene copolymer, polypropylene, polyethylene, polysulfone, and mixtures thereof.

At least one of the above and other features and advantages of the present invention may also be realized by providing a membrane including a porous support and an ion-exchange polymer, wherein the porous support includes a polymer and a reinforcing agent and the ion-exchange polymer is applied to the porous support, and the porous support is formed by forming a first mixture including a reinforcing agent and at least one of a polymer and a polymer precursor, and processing the first mixture to form the porous support.

The first mixture may further include an extractable material, and processing the first mixture to form the porous support may includes forming the first mixture into a membrane, and substantially removing the extractable material from the membrane by extracting the extractable material using a solvent. Approximately equal weights of the extractable material and the at least one of a polymer and a polymer precursor may be present in the first mixture.

The ion-exchange polymer may be applied to the porous support by forming a second mixture including an ion exchange material and a solvent. The ion-exchange polymer may be applied to the porous support by further applying the second mixture to the porous support and then substantially removing the solvent.

At least one of the above and other features and advantages of the present invention may further be realized by providing a fuel cell including an anode, a cathode and a membrane disposed between the anode and the cathode, the membrane including a porous support, and an ion-exchange polymer, wherein the porous support includes a polymer and a reinforcing agent and the ion-exchange polymer is applied to the porous support, and the porous support is formed by forming a first mixture including a reinforcing agent and at least one of a polymer and a polymer precursor, and processing the first mixture to form the porous support.

The anode and cathode may each include a catalyst and supply fuel gasses to the fuel cell. The first mixture may further include an extractable material, and processing the first mixture to form the porous support may include forming the first mixture into a membrane, and substantially removing the extractable material from the membrane by extracting the extractable material using a solvent. Approximately equal weights of the extractable material and the at least one of a polymer and a polymer precursor may be present in the first mixture.

The ion-exchange polymer may be applied to the porous support by forming a second mixture including an ion exchange material and a solvent. The ion-exchange polymer may be applied to the porous support by further applying the second mixture to the porous support and then substantially removing the solvent.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a structure of a proton-exchange membrane fuel cell;

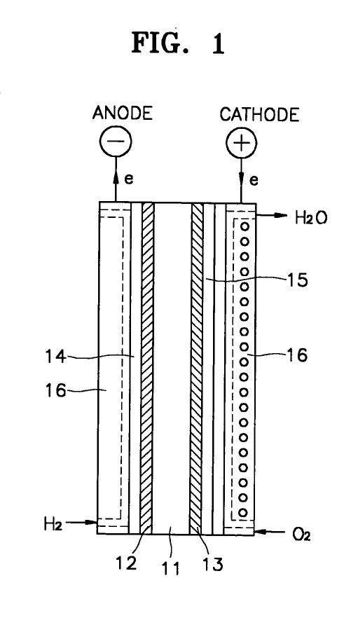

FIG. 2 illustrates a flow chart of steps in a method of making a reinforced composite ionic conductive polymer membrane according to the present invention;

FIG. 3 illustrates a graph comparing variations in cell potential with respect to current density for PEMFCs made according to the present invention and for comparative PEMFCs; and

FIG. 4 illustrates a graph comparing variations in current density at constant voltage with respect to time for PEMFCs made according to the present invention and for comparative PEMFCs.

### DETAILED DESCRIPTION OF THE INVENTION

Korean Patent Application No. 00-15580, filed on Mar. 27, 2000, and entitled “Reinforced Composite Ionic Conductive Polymer Membrane and Fuel Cell Adopting the Same,”is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Proton-exchange membrane fuel cells (PEMFCs) or direct methanol fuel cells (DMFCs) need to have high ionic conductivity, good moisture retention, and low methanol permeability.

According to the present invention, an ionic conductive polymer membrane may incorporate a reinforcing agent in the form of a moisture retentive material and/or a catalyst for, e.g., facilitating oxidation of hydrogen, along with an ion-exchange polymer (ionomer) in a porous support. To reduce cross-over of methanol through the polymer membrane, the ionic conductive polymer membrane according to the present invention may exhibit low methanol permeability.

Suitable ion-exchange polymers may include, e.g., sulfonated perfluorinated polymers, partially fluorinated polymers, and non-fluorinated polymers. The ion-exchange polymer may include, e.g., a sulfonic acid group (SO₃H), a carboxylic acid (COOH) group, a phosphoric acid (H₃PO₄) group, a perchloric acid group (HClO₄), and combinations thereof, as a reactive site, at an equivalent weight of about 600 to about 1200 g/H⁺. If the equivalent weight of the ion-exchange polymer is less than about 600 g/H⁺, membrane formation may not be easy, and the ion-exchange polymer may tend to aggregate in the porous support. If the equivalent weight of the ion-exchange polymer exceeds about 1200 g/H⁺, the membrane may exhibit an undesirably low ionic conductivity. The ion-exchange polymer may be, e.g., Nafione®115 (available from Dow Chemical Company, Midland, Mich., U.S.A.).

Examples of a reinforcing agent having excellent moisture retention include, e.g., SiO₂, TiO₂, ZrO₂, mordenite, tin oxide, zeolite, and combinations thereof. The catalyst, for facilitating electrochemical reactions of reactant gases provided to the electrodes, will be described in further detail below. The amount of the reinforcing agent used may be about 3 to 8%, by weight, based on the total weight of the ion exchange polymer.

Hydrogen supplied to the fuel cell is dissociated into protons and electrons by oxidation at the anode. However, irrespective of whether hydrogen is oxidized or not at the anode, the protons change back into hydrogen when passed through the ion-exchange polymer membrane. This inefficiency may be reduced or eliminated by addition of a catalyst that facilitates the oxidation of hydrogen. The catalyst may include, e.g., platinum (Pt), palladium (Pd), ruthenium (Ru), rhodium (Rh), iridium (Ir), gold (Au), a Pt/Ru alloy, and mixtures thereof.

Where both the moisture retentive material and the catalyst are used as the reinforcing agent, about 3 to about 90% moisture retentive material and about 10 to about 97% catalyst, by weight, may be used, based on the total weight of the reinforcing agent. If the amount of moisture retentive material is less than about 3% by weight, moisture retention effects may be negligible. If the amount of moisture retentive material is greater than about 90% by weight, it may not be possible to form the polymer into a membrane due to poor processibility.

In some implementations, the porous support may have about 30% or greater porosity, e.g., about 30 to about 80% porosity, and may have a pore size in the range from hundreds of nanometers to a few micrometers. The porous support may be formed as a continuous polymer sheet, or woven or non-woven fabric, with a thickness of, e.g., about 5 to about 50 μm. If the porous support has a porosity less than about 30%, the amount of ion-exchange polymer impregnated into the same may be limited, resulting in poor ionic conductivity. The porous support may include polymers such as polytetrafluoroethylene (PTFE), polyvinylidenefluoride (PVDF), vinylidene fluoride-hexafluoropropylene copolymer, polypropylene, polyethylene, polysulfone, and mixtures thereof. These porous supports have low methanol permeability, and thus cross-over of the methanol through the ionic conductive polymer membrane may be reduced.

The porous support may be formed by incorporating a proton-exchange functional group into a polymer layer including, e.g., PTFE, PVDF, vinylidenefluoride-hexafluoropropylene copolymer, polypropylene, polyethylene, polysulfone, etc., and mixtures thereof. The functional group may be, e.g., a group such as a carboxylic acid group, a sulfonic acid group, a phosphoric acid group, and/or a perchloric acid group. By grafting a sulfonic acid, phosphoric acid, perchloric acid, carboxylic acid, etc., side chain into the porous support, an increased amount of the ion-exchange polymer may be able to be incorporated into the porous support.

A method for forming a reinforced composite ionic conductive polymer membrane according to the present invention will now be described.

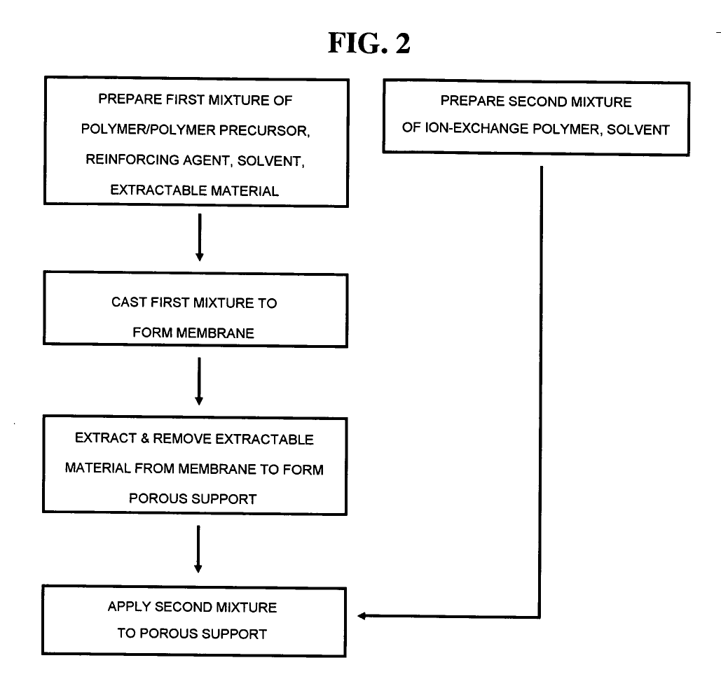

FIG. 2 illustrates a flow chart of steps in a method of making a reinforced composite ionic conductive polymer membrane according to the present invention. Referring to FIG. 2, a first mixture may be prepared from a polymer and/or polymer precursor, a reinforcing agent, a solvent, and an extractable material. One or more polymers and/or polymer precursors may be combined in the first mixture. Similarly, one or more reinforcing agents, solvents and extractable materials may be combined in the first mixture. The extractable material may be, e.g., an ether-soluble material such as, e.g., dibutyl phthalate (DBP). Preparing the first mixture may include various processing steps such as, e.g., drying, ball-milling, etc. The first mixture may then be processed into a membrane shape by, e.g., a casting process.

The extractable material may then be removed from the membrane to form a porous support. Where the extractable material is an ether-soluble material, the extractable material may be removed from the membrane by, e.g., soaking the membrane in ether. The porous support may be further processed if required by the particular application (not shown). Such further processing may include, e.g., providing the porous support with proton exchangeability by, e.g., pretreatment with light radiation, grafting on sulfonic acid, phosphoric acid, perchloric acid, or carboxylic acid side chains, etc.

A second mixture may be prepared from an ion-exchange polymer and a solvent. The second mixture may be applied to the porous support by, e.g., coating, soaking, spray coating, etc. After applying the second mixture to the porous support, the resultant coated porous support may then be dried. The drying temperature may be greater than the boiling point of the solvent and lower than the softening temperature of the ion-exchange polymer used. When an alcoholic solvent is used and a sulfonated perfluorinated polymer is used, the drying temperature may be in the range of about 60 to about 130° C. If the drying temperature is less than about 60° C., drying may be too slow. If the drying temperature is greater than about 130° C. or greater than the softening temperature of the ion-exchange polymer, the ion-exchange polymer may be oxidized.

In methods for forming the reinforced composite ionic conductive polymer membrane according to the present invention, the ion-exchange polymer and the reinforcing agent may be incorporated into the porous membrane, thus forming a reinforced composite ionic conductive polymer membrane.

A fuel cell according to the present invention may be manufactured by interposing the reinforced composite ionic conductive polymer membrane between an anode and a cathode to form a single cell.

The present invention will now be described in further detail by means of the following examples. However, it will be appreciated that the following examples are for illustrative purposes and are not intended to limit the scope of the invention.

### EXAMPLE 1

### lonomer/PVDF+SiO₂

6 g of Polyvinylidenefluoride (PVDF) copolymer, 3 g of SiO_{2,} 50 g of acetone and 6 g of dibutyl phthalate (DBP) were milled using ball-mill process, and then cast to obtain a membrane.

The membrane was soaked in ether, extracting and then removing DBP from the membrane to thus form a porous membrane.

A second mixture including 1 g of Nafion® 115 and 19 g of ethanol was coated on the porous membrane and then dried to obtain a reinforced composite ionic conductive polymer membrane.

A PEMFC was manufactured by disposing the reinforced composite ionic conductive polymer membrane of Example 1 between a Pt cathode and a Pt anode to form a single cell.

### EXAMPLE 2

### lonomer/PVDF+SiO₂

6 g of PVDF copolymer, 2 g of SiO_{2,} 50 g of acetone and 6 g of DBP were milled using a ball-mill process, and then cast to obtain a membrane.

The membrane was soaked in ether, extracting and then removing DBP from the membrane to thus form a porous membrane.

A second mixture including 1 g of Nafion® 115 and 19 g of ethanol was coated on the porous membrane and then dried to obtain a reinforced composite ionic conductive polymer membrane.

A PEMFC was manufactured by disposing the reinforced composite ionic conductive polymer membrane of Example 2 between a Pt cathode and a Pt anode to form a single cell.

### EXAMPLE 3

### lonomer/PVDF+SiO₂

6 g of PVDF copolymer, 3 g of SiO_{2,} 50 g of acetone and 8 g of DBP were milled using a ball-mill process, and then cast to obtain a membrane.

The membrane was soaked in ether, extracting and then removing DBP from the membrane to thus form a porous membrane.

A mixture including 1 g of Nafione® 115 and 19 g of ethanol was coated on the porous membrane and then dried to obtain a reinforced composite ionic conductive polymer membrane.

A PEMFC was manufactured by disposing the reinforced composite ionic conductive polymer membrane of Example 3 between a Pt cathode and a Pt anode to form a single cell.

### COMPARATIVE EXAMPLE 1

### lonomer/PVDF

6 g of PVDF copolymer, 50 g of acetone and 6 g of DBP were milled using a ball-mill process, and then cast to obtain a membrane.

The membrane was soaked in ether, extracting and then removing DBP from the membrane to thus form a porous membrane.

A mixture including 1 g of Nafion® 115 and 19 g of ethanol was coated on the porous membrane and then dried to obtain a membrane.

A PEMFC was manufactured by disposing the membrane of Comparative Example 1 between a Pt cathode and a Pt anode to form a single cell.

COMPARATIVE EXAMPLE 2

### lonomer+SiO₂/PVDF

6 g of PVDF copolymer, 50 g of acetone and 6 g of DBP were milled using a ball-mill process, and then cast to obtain a membrane.

The membrane was soaked in ether, extracting and then removing DBP from the membrane to thus form a porous membrane.

A mixture including 1 g of Nafion® 115, 0.05 g of SiO₂ and 19 g of ethanol was coated on the porous membrane and then dried to obtain a membrane.

A PEMFC was manufactured by disposing the membrane of Comparative Example 2 between a Pt cathode and a Pt anode to form a single cell.

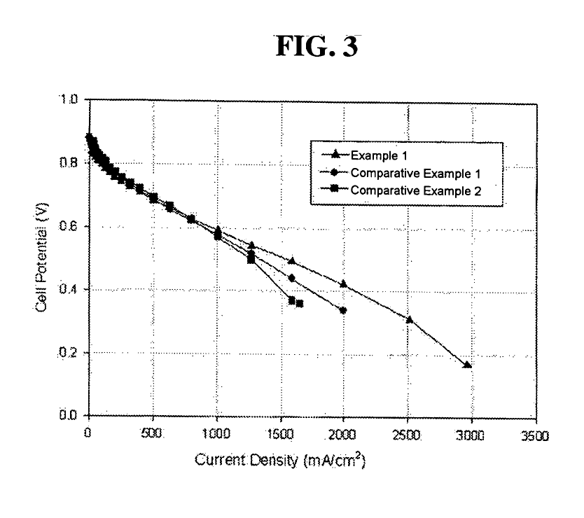

Cell efficiency was evaluated for the PEMFCs manufactured as detailed in the Examples and Comparative Examples, above, by measuring variations in cell potential with respect to current density. The results of this evaluation are shown in FIG. 3. In interpreting the results, a greater cell potential per current density is indicative of better cell efficiency. Referring to FIG. 3, the reinforced ionic conductive polymer membrane prepared in accordance with the present invention in Example 1 provides superior results, when compared to the membranes prepared according to Comparative Example 1 and Comparative Example 2.

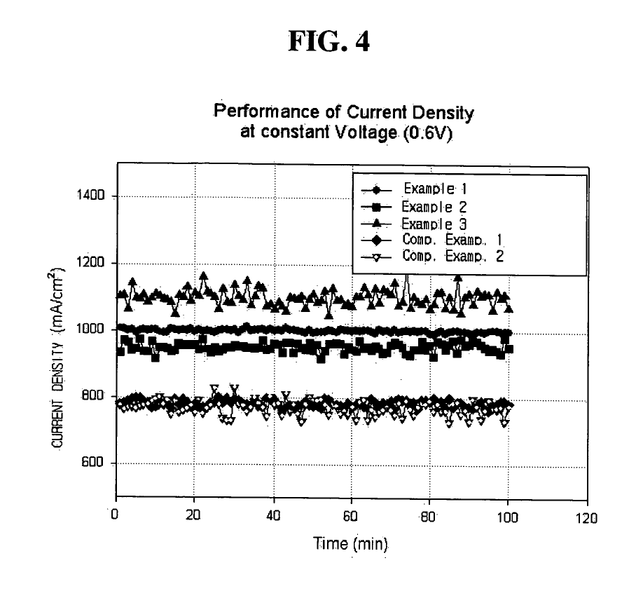

Cell efficiency was also evaluated for the PEMFCs manufactured in the Examples and Comparative Examples, above by measuring variations in current density at constant voltage (0.6 V) with respect to time. The results of this evaluation are shown in FIG. 4. Referring to FIG. 4, the PEMFCs of Examples 1-3 show better cell performance than the PEMFCs of Comparative Examples 1 and 2. That is, the PEMFCs prepared using membranes prepared in accordance with the present invention in Examples 1-3 exhibit current densities of approximately 1000 mA/cm^{2,} 950 mA/cm², and 1100 mA/cm², respectively. In contrast, the PEMFCs prepared using membranes prepared in accordance with Comparative Examples 1-2 exhibit lower current densities of approximately 775 mA/cm^{2.}

The reinforced composite ionic conductive polymer membrane according to the present invention may exhibit good moisture retention, and thus drying of the polymer membrane at high temperature may be reduced or prevented while maintaining high ionic conductivity. Further, it may be easily processed as a film, and a fuel cell with improved cell efficiency may be manufactured therewith. The reinforced composite ionic conductive polymer membrane according to the present invention may also be effective in suppressing methanol cross-over in DMFCs.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of making a membrane, comprising:
forming a porous support, the porous support including a polymer and a reinforcing agent; and
applying an ion-exchange polymer to the porous support.

2. The method as claimed in claim 1, wherein forming the porous support includes:
forming a first mixture including a reinforcing agent and at least one of a polymer and a polymer precursor; and
processing the first mixture to form the porous support.

3. The method as claimed in claim 2, wherein the first mixture further includes an extractable material, and processing the first mixture to form the porous support includes:
forming the first mixture into a membrane, and substantially removing the extractable material from the membrane by extracting the extractable material using a solvent.

4. The method as claimed in claim 3, wherein approximately equal weights of the extractable material and the at least one of a polymer and a polymer precursor are present in the first mixture.

5. The method as claimed in claim 3, wherein forming the first mixture into a membrane includes casting the first mixture.

6. The method as claimed in claim 1, wherein applying the ion-exchange polymer to the porous support includes forming a second mixture including an ion exchange material and a solvent.

7. The method as claimed in claim 6, wherein applying the ion-exchange polymer to the porous support further includes applying the second mixture to the porous support and then substantially removing the solvent.

8. The method as claimed in claim 1, wherein the polymer is selected from the group consisting essentially of polytetrafluoroethylene, polyvinylidenefluoride, vinylidene fluoride-hexafluoropropylene copolymer, polypropylene, polyethylene, polysulfone, and mixtures thereof.

9. A membrane, comprising:
a porous support; and
an ion-exchange polymer, wherein the porous support includes a polymer and a reinforcing agent and the ion-exchange polymer is applied to the porous support, and
the porous support is formed by:
forming a first mixture including a reinforcing agent and at least one of a polymer and a polymer precursor; and
processing the first mixture to form the porous support.

10. The membrane as claimed in claim 9, wherein the first mixture further includes an extractable material, and processing the first mixture to form the porous support includes:
forming the first mixture into a membrane, and
substantially removing the extractable material from the membrane by extracting the extractable material using a solvent.

11. The membrane as claimed in claim 10, wherein approximately equal weights of the extractable material and the at least one of a polymer and a polymer precursor are present in the first mixture.

12. The membrane as claimed in claim 9, wherein the ion-exchange polymer is applied to the porous support by forming a second mixture including an ion exchange material and a solvent.

13. The membrane as claimed in claim 12, wherein the ion-exchange polymer is applied to the porous support by further applying the second mixture to the porous support and then substantially removing the solvent.

14. A fuel cell, comprising:
an anode, a cathode and a membrane disposed between the anode and the cathode, the membrane including:
a porous support; and
an ion-exchange polymer, wherein the porous support includes a polymer and a reinforcing agent and the ion-exchange polymer is applied to the porous support, and
the porous support is formed by:
forming a first mixture including a reinforcing agent and at least one of a polymer and a polymer precursor; and
processing the first mixture to form the porous support.

15. The fuel cell as claimed in claim 14, wherein the anode and cathode each include a catalyst and supply fuel gasses to the fuel cell.

16. The fuel cell as claimed in claim 14, wherein the first mixture further includes an extractable material, and processing the first mixture to form the porous support includes:
forming the first mixture into a membrane, and
substantially removing the extractable material from the membrane by extracting the extractable material using a solvent.

17. The fuel cell as claimed in claim 16, wherein approximately equal weights of the extractable material and the at least one of a polymer and a polymer precursor are present in the first mixture.

18. The fuel cell as claimed in claim 14, wherein the ion-exchange polymer is applied to the porous support by forming a second mixture including an ion exchange material and a solvent.

19. The fuel cell as claimed in claim 18, wherein the ion-exchange polymer is applied to the porous support by further applying the second mixture to the porous support and then substantially removing the solvent.
